(19) United States
(12) Patent Application Publication
(10) Pub. No.: US 2005/0254793 A1
(43) Pub. Date: Nov. 17, 2005

(54) Method of controlling digital image processing apparatus and digital image processing apparatus using the method

(75) Inventors: Hyuk-soo Son, Seongnam-si (KR); Hee-jin Suh, Changwon-si (KR); Dong-hwan Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/064,398

(22) Filed: Feb. 23, 2005

(30) Foreign Application Priority Data
May 15, 2004 (KR) 10-2004-0034544

(51) Int. Cl. H04N 5/225

(52) U.S. Cl. 386/117; 348/207.99

(57) ABSTRACT

Provided is a method of controlling a digital image processing apparatus that takes a photograph of a subject, stores an image file for the subject in a storage medium, reproduces the image file stored in the storage medium, and displays the image file on a display panel. The method includes; retrieving photographing information stored in the image file and copying the retrieved photographing information to an area of a user setting memory according to a user's choice when the image file stored in the storage medium is reproduced; and reading the photographing information stored in the area of the user setting memory and taking a photograph of the subject based on the read photographing information.

### CROSS-REFERENCE TO RELATED PATENT APPLICATIONS

This application claims the priority of Korean Patent Application No. 10-2004-0034544, filed on May 15, 2004, in the Korean Intellectual Property Office, the disclosure of which is incorporated herein in its entirety by reference.

### BACKGROUND OF THE INVENTION

1. Field of the Invention

The present invention relates to a method of controlling a digital image processing apparatus and a digital image processing apparatus using the method, and more particularly, to a method of controlling a digital image processing apparatus that takes a photograph of a subject, stores an image file for the subject in a storage medium, reproduces the image file stored in the storage medium and displays the image file on a display panel, and a digital image processing apparatus using the method.

2. Description of the Related Art

A conventional digital image processing apparatus such as, for example, the digital cameras disclosed in U.S. Pat. No. 5,416,556, “Custom Mode Control Apparatus in Camera,” and in Japanese Patent Publication No. 254,837, “Custom Mode Control Device for Camera,” 1992, include a storage medium and a display panel. Images obtained by the apparatus when set in a photographing mode are stored in the storage medium. When the apparatus is set in a reproduction mode a stored image selected by a user is displayed (i.e., reproduced) on a display panel.

By using the conventional digital image processing apparatus in the photographing mode, current photographing information (e.g., manual settings for shutter speed, sensitivity (ISO), resolution, etc.) can be stored in a setting area (e.g., a memory) and the stored photographing information can be recalled and used again when desired as a photographing condition for photographing an image. However, if the user does not store the photographing information at the time of a photographing operation the photographing information cannot be recalled and re-used as a photographing condition.

### SUMMARY OF THE INVENTION

The present invention provides a method of controlling a digital image processing apparatus and a digital image processing apparatus using the method which enables a user to reuse photographing information used when capturing a first image as photographing conditions for capturing a second image even though the user did not intentionally store the photographing information at the time of the first photographing operation.

According to an aspect of the present invention, there is provided a method of controlling a digital image processing apparatus that takes a photograph of a subject, stores an image file for the subject in a storage medium, reproduces the image file stored in the storage medium, and displays the image file on a display panel. The method includes: obtaining photographing information that is stored in an image file when the image file is reproduced from image data in the storage medium; storing the photographing information in an area of a user setting item; reading the photographing information stored in the area of the user setting item; and taking a photograph of the subject based on the read photographing information.

In the method, photographing information stored in an image file can be reused as photographing conditions when the image file is reproduced according to a user's choice. Accordingly, the user can reuse the photographing information as photographing conditions even though the user did not store the photographing information at the time of a photographing operation.

According to another aspect of the present invention, there is provided a digital image processing apparatus using the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of a digital camera according to the present invention;

FIG. 2 is a perspective view illustrating the back of the digital camera of FIG. 1;

FIG. 3 is a schematic diagram of the entire configuration of the digital camera of FIG. 1;

FIG. 4 is a flowchart illustrating a main algorithm of a digital signal processor (DSP) illustrated in FIG. 3;

FIG. 5 is a flowchart illustrating a reproduction algorithm of FIG. 4;

FIG. 6 is a flowchart illustrating operation S506 of FIG. 5;

FIG. 7 is a screen of a color LCD panel obtained as a result of performing operation S507 of FIG. 5 according to an embodiment of the present invention;

FIG. 8 is a screen of the color LCD panel obtained as a result of performing operation S601 of FIG. 6 according to an embodiment of the present invention;

FIG. 9 is a flowchart illustrating a photographing algorithm of FIG. 4; and

FIG. 10 is a flowchart illustrating operation S701a of FIG. 9.

### DETAILED DESCRIPTION OF THE INVENTION

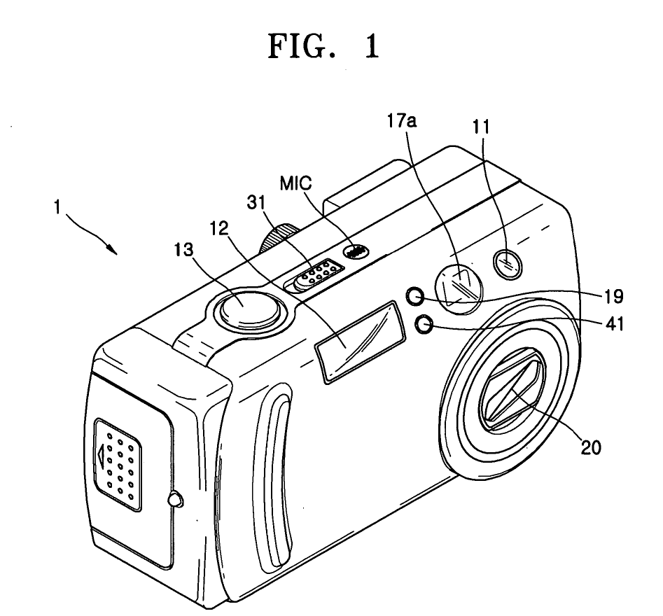

Referring to FIG. 1, the front part of a digital camera 1 according to an embodiment of the present invention includes a microphone MIC, a self-timer lamp 11, a flash 12, a shutter button 13, a viewfinder 17a, a flash light intensity sensor 19, a power switch 31, a lens unit 20, and a remote receiver 41.

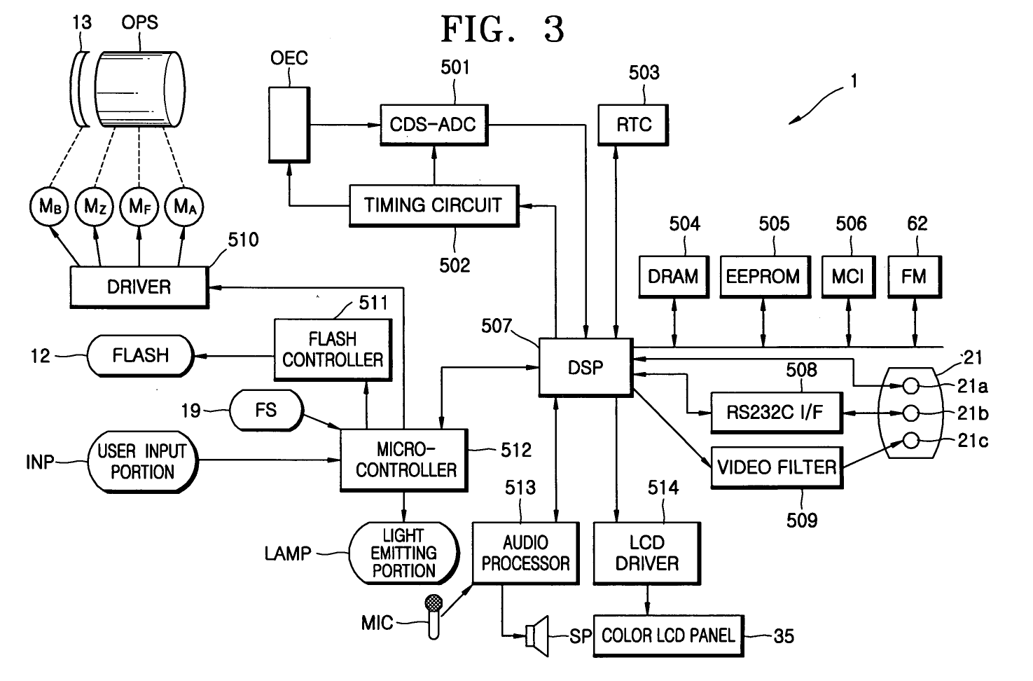

In a self-timer mode, the self-timer lamp 11 operates for a set period of time from the time when the shutter button 13 is pressed to the time when a shutter operates. When the flash 12 operates, the flash light intensity sensor 19 senses the intensity of the light generated by the flash 12 and relays the sensed intensity of the light to a digital signal processor (DSP) 507 of FIG. 3 via a micro-controller 512 of FIG. 3. The remote receiver 41 receives command signals, for example, a photographing command signal, from a remote controller (not shown) and relays the photographing command signal to the DSP 507 via the micro-controller 512.

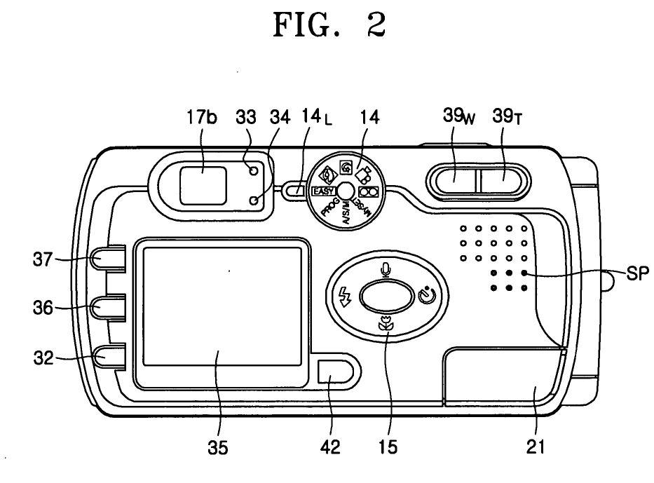

Referring to FIG. 2, the back of the digital camera 1 according to an embodiment of the present invention includes a mode dial 14, functional buttons 15, a manual focus/delete button 36, a manual adjust/reproduce button 37, a reproduction mode button 42, a speaker SP, a monitor button 32, an automatic focusing lamp 33, a viewfinder 17b, a flash standby lamp 34, a color LCD panel 35, a wide angle-zoom button 39_{W}, a telephoto-zoom button 39_{T}, and an external interface unit 21.

The mode dial 14 is used for selecting any one of the operating modes of the digital camera 1 such as an automatic still-image photographing mode, a night view photographing mode, a moving-image photographing mode, a manual still-image photographing mode, a reproduction mode, a computer connection mode, and a system setting mode.

The functional buttons 15 are used for operating specific functions of the digital camera 1 and the functional buttons 15 are also used as control buttons to manage the movement of an active cursor. The manual focus/delete button 36 is used for manual focusing or deleting in the photographing mode. The manual adjust/reproduce button 37 is used for manual adjustment of specific photographing conditions/settings (e.g., resolution, shutter speed, sensitivity, white balance, etc.) and for termination or reproduction in the reproduction mode. The reproduction mode button 42 is used for switching the camera's operation between the reproduction mode and the photographing mode.

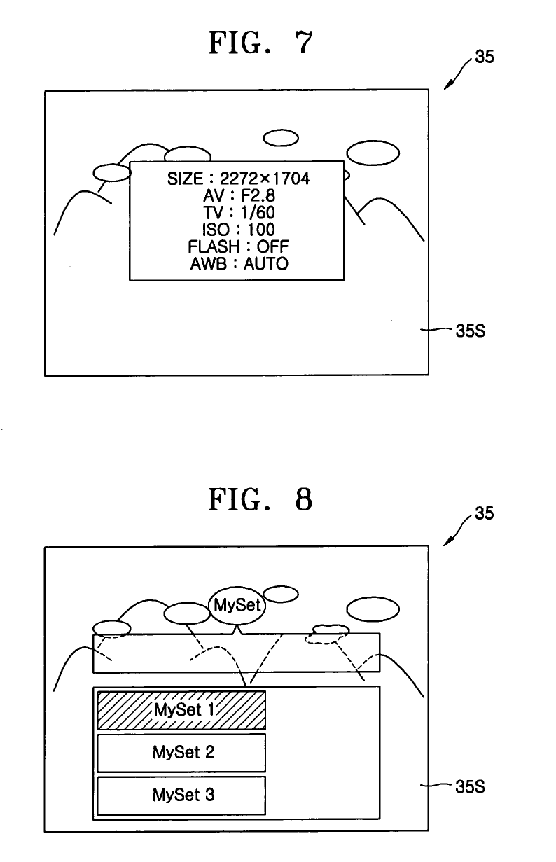

The monitor button 32 is used for controlling the operation of the display panel 35, herein a color LCD. For example, in the photographing mode, when the user presses the monitor button 32, an image and photographing information (e.g., mode information, flash information, etc.) are displayed on the color LCD panel 35. When the user presses the monitor button 32 again, the color LCD panel 35 is turned off. In the reproduction mode, which may be used to review captured images that are stored in a storage medium, when the user presses the monitor button 32 while an image file is being reproduced (i.e., displayed on the panel 35), photographing information about the image file is displayed on the color LCD panel 35 along with the reproduced image (see FIG. 7). When the user presses the monitor button 32 again in the reproduction mode only pure images are displayed.

In the reproduction mode the user can store photographing information of an image file that is being reproduced to a user setting area (e.g., a memory as shown in FIG. 8) for later recall and use by pressing the monitor button 32 for a duration of time (e.g., more than one second). Accordingly, even though the user does not store photographing information at the time of a photographing operation, the photographing information is stored with the image data in an image file so that the photographing information can be obtained (e.g., by a data extraction and copying process) and re-used as photographing conditions, which will be described in detail later.

The automatic focusing lamp 33 operates when a focus is well adjusted. The flash standby lamp 34 operates when the flash 12 of FIG. 1 is in a standby mode. A mode indicating lamp 14_{L} indicates a selection mode of the mode dial 14.

FIG. 3 is a schematic diagram illustrating an example configuration of the digital camera 1 of FIG. 1. The configuration and operation of the digital camera 1 of FIG. 1 will now be described with reference to FIGS. 1 through 3.

A transparent barrier 13 preventing foreign matter from adhering to an optical system (OPS) is open or closed by a barrier motor MB. The OPS, which includes the lens unit 20 and a filter unit (not shown), optically processes light from a photographing subject. The lens unit 20 of the OPS includes a zoom lens, a focal lens, and a compensation lens.

When the user presses the wide angle-zoom button 39_{W} or the telephoto-zoom button 39_{T} included in a user input portion (INP), a signal corresponding to the wide angle-zoom button 39_{W} or the telephoto-zoom button 39_{T} is relayed to the micro-controller 512. The micro-controller 512 controls a driver 510, thereby running a zoom motor M_{Z}, which in turn, moves the zoom lens. In other words, when the user presses the wide angle-zoom button 39_{W}, the focal length of the zoom lens becomes short, thereby widening the angle of view. When the user presses the telephoto-zoom button 39_{T}, the focal length of the zoom lens becomes long, thereby narrowing the angle of view. Since the position of the focal lens is adjusted in a state where the position of the zoom lens is set, the angle of view is hardly affected by the position of the focal lens.

In the automatic focusing mode, a main controller (not shown) built into the DSP 507 controls the driver 510 through the micro-controller 512, thereby driving a focus motor M_{F}. Accordingly, when the focal lens is moved by the focus motor M_{F} the position of the focal lens can be determined by, for example, a number of driving steps of the focus motor M_{F}. Thus, in an automatic-focusing still-image photographing mode the DSP 507 may, for example, drive the focus motor M_{F} until the image is focused as determined by when the image signal has a greatest high frequency component. Accordingly, the DSP 507 may, when capturing an image, store the position of the focal lens along with the image data.

The compensation lens in the lens unit 20 of the OPS is not separately operated because the compensation lens compensates for the entire refractive index. Reference numeral MA indicates a motor for driving an aperture (not shown).

An optical low pass filter included in the filter unit of the OPS eliminates high frequency optical noise. An infrared cut filter included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real time clock (RTC) 503 provides time information to the DSP 507. The DSP 507 processes the digital signal from the CDS-ADC 501 and generates a digital image composed of luminance and chromaticity values.

A light emitting portion (LAMP) is operated by the micro-controller 512 in response to a control signal generated by the DSP 507 including the main controller. The light emitting portion (LAMP) includes the self-timer lamp 11, the automatic focusing lamp 33, the mode indicating lamp 14_{L}, and the flash standby lamp 34. The user input portion INP includes the shutter button 13, the mode dial 14, the functional buttons 15, the monitor button 32, the manual focus/delete button 36, the manual adjust/reproduce button 37, the wide angle-zoom button 39_{W}, and the telephoto-zoom button 39_{T}.

A dynamic random access memory (DRAM) 504 temporarily stores a digital image signal from the DSP 507. An electrically erasable and programmable read only memory (EEPROM) 505 stores algorithms and setting data. A user's memory card is inserted or removed in a memory card interface 506. The digital image signal from the DSP 507 is input to an LCD driver 514, thereby displaying an image on the color LCD panel 35.

The digital image signal from the DSP 507 can be transmitted via a universal serial bus (USB) connector 21a or via an RS232C interface 508 and an RS232C connector 21b for serial communications. The digital image signal from the DSP 507 can also be transmitted via a video filter 509 and a video output unit 21c as a video signal.

An audio processor 513 can relay sound from the microphone MIC to the DSP 507 or to speaker SP. In addition, the audio processor 513 can output an audio signal from the DSP 507 to the speaker SP. The micro-controller 512 controls the operation of a flash controller 511 in response to a signal from the flash light intensity sensor 19, thereby driving the flash 12.

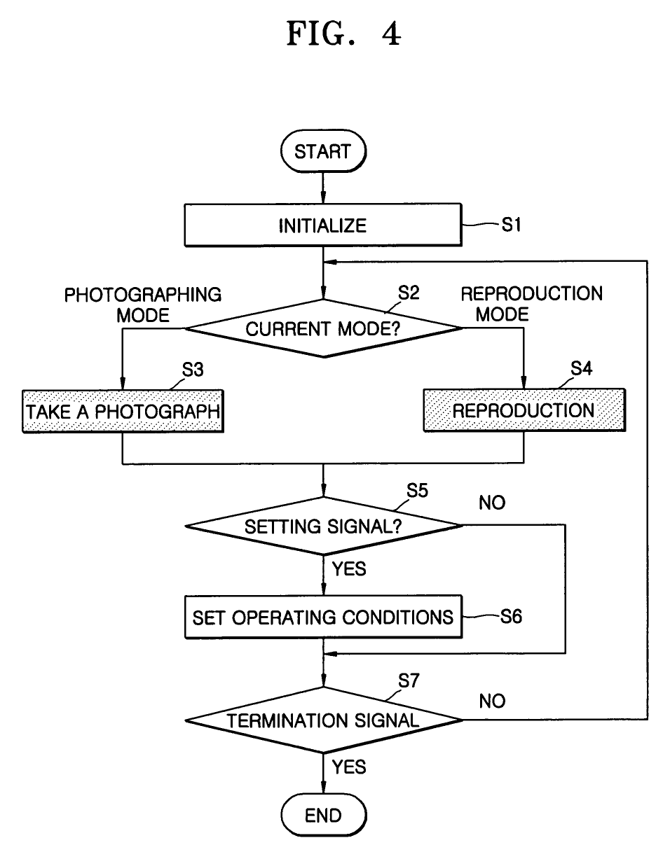

A main algorithm of the DSP 507 of FIG. 3 will be now described with reference to FIG. 4.

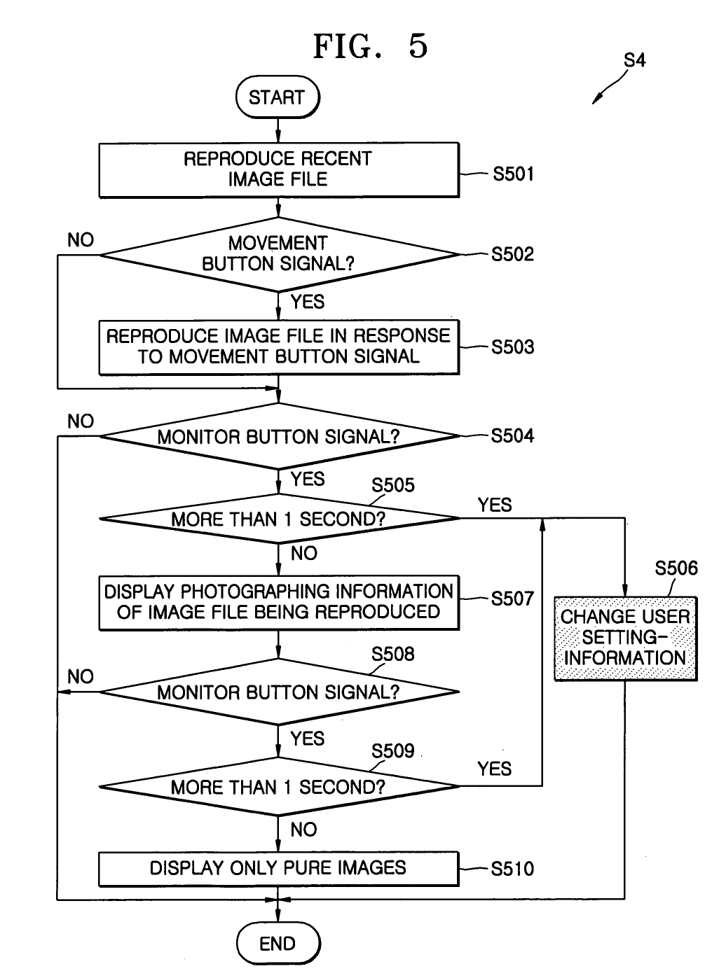

When the digital camera 1 is turned on the DSP 507 is initialized (S1). After the initialization (S1), the DSP 507 enters a current mode (S2) that is selected/set by the user (e.g., by moving the mode dial 14). If the current mode is determined to be a reproduction mode (e.g., according to the sequence in which the reproduction mode button 42 included in the user input portion INP is pressed) the DSP 507 controls reproduction (S4). Here, when an image file stored in the storage medium is reproduced (i.e., displayed), photographing information stored in the image file with the image data being reproduced may be stored in a user setting area (e.g., a memory), which will be described in detail later with reference to FIGS. 5 through 8.

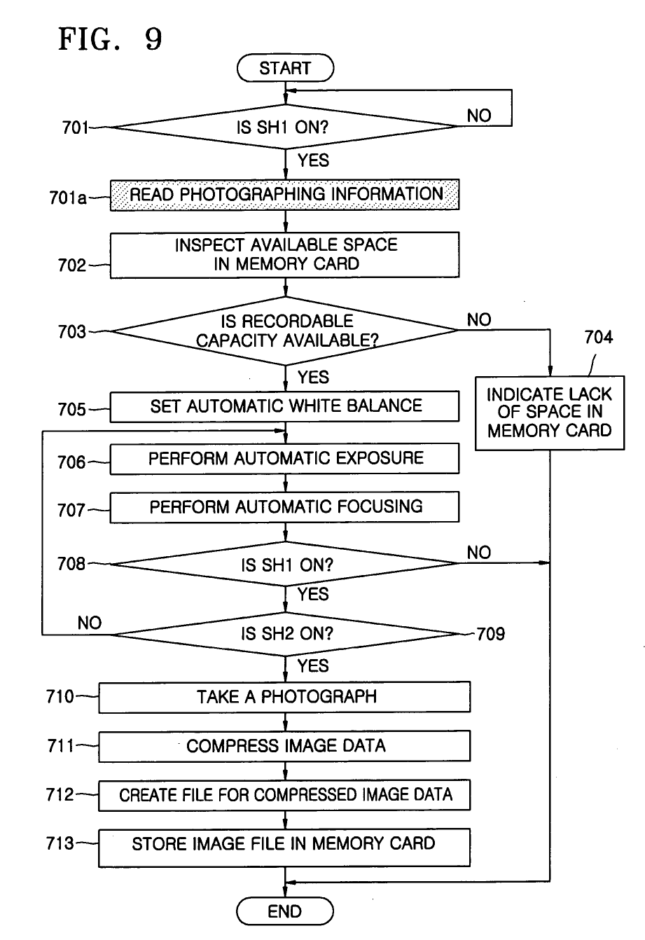

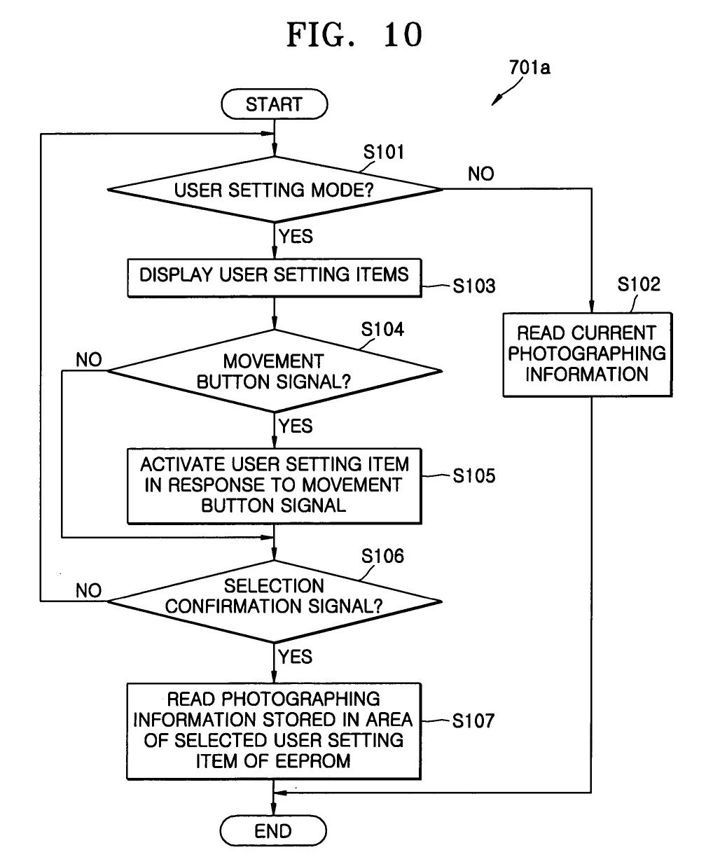

If the current mode is determined to be one of the photographing modes (e.g., according to the sequence in which the reproduction mode button 42 included in the user input portion INP is pressed) the DSP 507 controls photographing (S3). Here, photographing information stored in the user setting area is read according to the user's choice and a subject is photographed based on the read photographing information, which will be described in detail later with reference to FIGS. 9 and 10.

While performing the photographing operation (S3) or the reproduction operation (S4), if a signal indicating that operating conditions of the digital camera 1 should be set is received from the user input portion INP (S5), the DSP 507 sets operating conditions in various modes in response to a command signal generated by the user (S6).

The above operations are repeated until a termination signal is input to the DSP 507 (operation S7).

FIG. 5 is a flowchart illustrating the reproduction (S4) algorithm shown in FIG. 4. FIG. 7 illustrates a display 35S on the color LCD panel 35 that is obtained as a result of performing operation S507 of FIG. 5 according to an embodiment of the present invention. The reproduction (S4) algorithm will now be described with reference to FIGS. 2, 5, and 7.

Of files stored in the memory card, a recent image file is reproduced as display 35S on the color LCD panel 35 (S501). When a movement button signal is generated by the functional buttons 15 (S502) another image file is reproduced in response to the movement button signal (S503). That is, for example, a user may navigate a plurality of displayed thumbnail images and select one image for viewing on the panel by pressing the functional buttons 15.

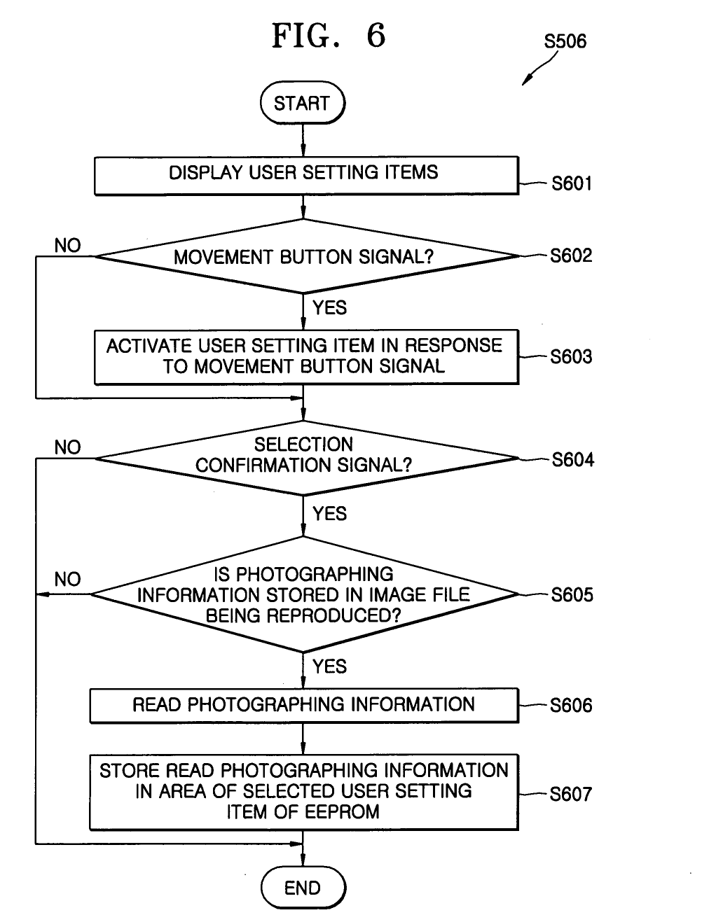

Now, when the desired image is displayed and a user presses the monitor button 32 for more than a predetermined period of time (e.g., one second) to generate an extended duration monitor button signal (S504 and S505), a user setting-information changing operation is performed (S506). In the user setting-information changing operation (S506), photographing information stored in the image file with the image data being reproduced is stored in a user setting area (e.g., a memory) according to the user's choice, which will be described in detail later with reference to FIGS. 6 and 8.

However, when the user presses the monitor button 32 for less than a predetermined period of time (e.g., one second) to generate a short duration monitor button signal (S504 and S505), the photographing information stored in the image file with the image data being reproduced is displayed on the color LCD panel 35 as illustrated in FIG. 7 (S507).

Thereafter, when the user presses the monitor button 32 for more than a predetermined period of time (e.g., one second) to generate an extended duration monitor button signal (S508 and S509), the user setting-information changing operation (S506) is performed.

Alternatively, when the user presses the monitor button 32 for less than a predetermined period of time (e.g., one second) to again generate a short duration monitor button signal (S508 and S509), only pure images of the image file being reproduced are displayed on the screen 35S of the color LCD panel 35 (S510). That is, image data is reproduced from the image file without displaying the corresponding stored photographing information in the image file.

FIG. 6 is a flowchart illustrating in further detail the user setting-information changing algorithm (S506) of FIG. 5. FIG. 8 is a display 35S on the color LCD panel 35 that is obtained as a result of performing operation S601 of FIG. 6 according to an embodiment of the present invention. The user setting-information changing (S506) algorithm of FIG. 5 will now be described with reference to FIGS. 2, 6, and 8.

Referring to FIG. 8, user setting items comprising memories, registers or the like that are designated as displayed icons MySet 1, MySet 2, and MySet 3 are displayed on the screen 35S of the color LCD panel 35. When the camera user operates the functional buttons 15 to generate a movement button signal (S602), a user setting item is activated (i.e., selected) in response to the movement button signal (S603). For example, as illustrated in FIG. 8, the MySet 1 icon is activated (i.e., selected), which is indicated herein by the hatching/highlighting of the MySet 1 icon, but the MySet 2 and MySet 3 icons may be selected by pressing the functional buttons 15 (e.g., a down button).

When the desired user setting item has been activated the user may then generate a selection confirmation signal (e.g., by pressing an “OK” button positioned in the middle of the functional buttons 15). The DSP 507 waits to receive the selection confirmation signal (S604) and after receiving the signal then determines whether photographing information is stored with the image data of the image file that is being reproduced (S605).

If the photographing information is indeed present in the image file being reproduced, the stored photographing information is then read (S605). The read photographing information is then duplicated and stored in the user setting area (e.g., in the EEPROM 505 of FIG. 3) according to the activated icon that provides a visual representation of the user setting area.

As one can appreciate, only a portion of the read photographing information may be stored in the user setting area. That is, of the read photographing information, information that varies whenever the user takes a photograph (e.g., information regarding aperture values, flash 12 operation information, and photograph date) may not be extracted, copied and stored.

As described above, since photographing information of an image file being reproduced is stored in the user setting area according to a user's choice, one can appreciate that the user can retrieve the photographing information from one photographed image for use as photographing conditions (i.e., settings) for taking another photograph. In this way, even though the user did not store or forgot to store the photographing information at the time of photographing the subject (e.g., a landscape or portrait), the user can reuse the stored photographing information for the purpose of taking a photograph of a similar subject (e.g., another landscape or portrait).

The photographing algorithm (S3) of FIG. 4 will now be described in further detail with reference to FIGS. 1 through 3 and 9. The shutter button 13 included in the user input portion INP has two levels. In other words, after operating one or more of the user input INP buttons including the wide angle-zoom button 39_{W} and the telephoto-zoom button 39_{T} in preparation to take a photograph, the user then presses the shutter button 13 to a first level so that a first level signal SH1 from the shutter button 13 is turned on. When the user presses the shutter button 13 to a second level, a second level signal SH2 from the shutter button 13 is turned on. Thus, one can appreciate that the photographing algorithm of FIG. 9 starts when the user presses the shutter button 13 to the first level (operation 701). Here, the current position of the zoom lens is already set.

Photographing information is read for example, from the foregoing described user setting area, to set photographing conditions (operation 701a). The operation of reading photographing information (701a) will be described in detail later with reference to FIG. 10.

Next, the DSP 507 inspects the remaining capacity of the memory card (operation 702) and determines whether the memory card has enough capacity to store image data (operation 703). If the memory card does not have enough storage capacity, the DSP 507 indicates the lack of capacity of the memory card (operation 704) and terminates the photographing operation. However, if the memory card has enough storage capacity, the following operations are performed.

The DSP 507 performs automatic white balancing (AWB) and sets parameters related to the AWB according to the photographing information read in operation 701a (operation 705). Then, the DSP 507 performs an automatic exposure (AE) mode according to the photographing information read in operation 701a (operation 706). For example, the DSP 507 may calculate the exposure by measuring incident luminance and then drive the aperture driving motor MA according to the calculated exposure.

The DSP 507 next performs automatic focusing according to the photographing information read in operation 701a (operation 707) to set the position of the focal lens.

The DSP 507 determines whether the first level signal SH1 from the shutter button 13 is still on (operation 708). If the first level signal SH1 from the shutter button 13 is not on, it means that the user does not wish to take a photograph at that instant and the photographing operation is terminated. However, if the first level signal SH1 from the shutter button 13 is still on, the following operations are performed.

The DSP 507 determines whether the second level signal SH2 is on (operation 709). When the second level signal SH2 is not on, it means that the user did not press the shutter button 13 to the second level to take a photograph. Therefore, the DSP 507 goes back to operation 706 to cycle through operations 706 through 709 until second level signal SH2 is detected to be on.

When the second level signal SH2 is on, it means that the user pressed the shutter button 13 to the second level to take a photograph at that instant. Thus, the DSP 507 performs a photographing operation (operation 710). For example, referring to FIG. 3, the DSP 507 controls the timing circuit 502 to operate the OEC and the CDS-ADC 501. The DSP 507 compresses image data (operation 711) and creates a file for the compressed image (operation 712). The DSP 507 then transmits the file for the compressed image to the memory card via the memory card interface 506 (operation 713).

The operation (701a) of reading photographing information of FIG. 9 will now be described in further detail with reference to FIGS. 2 and 10.

The camera 1 determines if it is set in a user setting mode (S101). For example, the DSP 507 may discriminate the orientation of the mode dial 14 to determine if the mode indicating lamp 14_{L} is aligned with a selection on the mode dial 14 such as a user setting mode (“MySet”). If the user setting mode is not selected and the camera 1 is set in, for example, an automatic focusing still picture photographing mode, current photographing information (e.g., automatic focusing information) is read from a photographing information memory or the like (S102). However, if the user setting mode is selected, the following operations are performed.

The user setting items (e.g., icons that provide a visual representation of the various stored user setting areas) are displayed (S103). When the movement button signal is generated by the functional buttons 15 (S104), a selected user setting item is activated in response to the movement button signal (S105).

Then, after activating a user setting item, when the selection confirmation signal is generated in step S106 (e.g., by the “OK” button in the middle of the functional buttons 15), photographing information stored in the user selected area (e.g., in the EEPROM 505 of FIG. 3) is read (S107).

As described above, according to a method of controlling a digital image processing apparatus and a digital image processing apparatus using the method, photographing information stored in an image file can be reused as photographing conditions when the image file is reproduced according to a user's choice. Accordingly, the user can reuse the photographing information as photographing conditions even though the user did not intentionally store the photographing information at the time of a photographing operation.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of controlling a digital camera apparatus including a storage medium and a display screen, the method comprising:
photographing a first subject according to a photographing information;
storing an image file for the first subject in the storage medium, the image file including image data and the photographing information;
extracting the photographing information from the image file; and
setting a photographing condition for taking a photograph of a second subject, wherein the photographing condition is based on the photographing information from the extracting step.

2. The method of claim 1 wherein the photographing information comprises photographing settings selected from the group consisting of an image resolution, an aperture value, a shutter speed, a sensitivity, a white balance and a flash setting.

3. The method of claim 1 wherein the setting step comprises:
reproducing the image file stored in the storage medium;
reading the photographing information stored in the image file;
applying the photographing information from the reading step to a user setting memory.

4. The method of claim 3 wherein the reproducing step comprises:
selecting the image file from a plurality of image files stored in the storage medium; and
displaying on the display screen an image according to the image data stored in the image file from the selecting step.

5. The method of claim 3 wherein the applying step comprises:
selecting the user setting memory;
copying the photographing information stored in the image file; and
populating at least a portion of the user setting memory with the photographing information from the copying step.

6. The method of claim 4 further comprising the step of determining if a user input button has been pressed for a first duration greater than a first predetermined period of time when the image is being displayed.

7. The method of claim 6 wherein the first predetermined period of time is approximately one second.

8. The method of claim 6 wherein the user input button comprises a monitor button that is operative to control the display screen.

9. The method of claim 6 further comprising the step of displaying on the display screen with the image the photographing information stored in the image file if the first duration is less than the first predetermined period of time.

10. The method of claim 9 further comprising the step of determining if the user input button has been pressed for a second duration greater than a second predetermined period of time when the image and the photographing information are being displayed.

11. The method of claim 10 wherein the second predetermined period of time is approximately one second.

12. The method of claim 10 wherein the second predetermined period of time is equal to the first predetermined period of time.

13. A digital image processing apparatus that takes a photograph of a subject, stores an image file for the subject, reproduces the image file, and displays the image file on a display panel, the apparatus comprising:
an optical system that receives a light reflected from the subject, the optical system including a lens unit having an aperture, a zoom lens, a focal lens and a compensation lens;
a photoelectric converter in optical communication with the lens unit for receiving a focused image of the light reflected from the subject and converting said focused image into an image signal;
a processor subsystem linked with the optical system for driving the lens unit according to a photographing setting, and in communication with the photoelectric converter for receiving the image signal; and
a storage medium linked with the processor subsystem for storing the photographing setting and image data relative to the image signal in an image file, wherein the processor subsystem is operative to retrieve the photographing setting from the image file and apply said photographing setting for a subsequent photographing operation.

14. The digital image processing apparatus of claim 13 wherein the processor subsystem comprises:
a micro-controller linked with a focus motor to move the focus lens by a number of driving steps that relate to a focal length, and linked with an aperture motor for driving the aperture with a shutter speed; and
a digital signal processor in communication with the micro-controller for receiving a signal indicating the focal length and the shutter speed relative to the image signal.

15. The digital image processing apparatus of claim 14 further comprising a combination correlation double sampler and analog to digital converter that processes the image signal by eliminating high frequency noise, adjusting signal amplitude and converting the image signal to a digital signal, the combination correlation double sampler and analog to digital converter linking the photoelectric converter to the digital signal processor.

16. The digital image processing apparatus of claim 14 further comprising:
a user input portion linked with the processor subsystem and including a user input button that outputs a user setting changing signal when the apparatus is set in a reproducing mode and the user input button is actuated for a predetermined period of time;
a user setting memory; and
wherein the digital signal processor obtains the photographing setting from the image file and copies the photographing setting to the user setting memory when the micro-controller detects the user setting changing signal.

17. The digital image processing apparatus of claim 16 wherein the predetermined period of time is approximately one second.

18. The digital image processing apparatus of claim 16 wherein the user input button is a monitor button that is operative to control the display panel.

19. The digital image processing apparatus of claim 18 wherein the display panel comprises a color liquid crystal display.

20. The digital image processing apparatus of claim 16 wherein the photographing setting includes values selected from the group consisting of an image resolution, an aperture value, a shutter speed, a sensitivity, a white balance and a flash setting.
